(19) United States
(12) Patent Application Publication
(10) Pub. No.: US 2009/0047551 A1
(43) Pub. Date: Feb. 19, 2009

(54) METHODS OF OPERATING FUEL CELL SYSTEMS HAVING A HUMIDIFICATION DEVICE

(76) Inventor: Janusz Blaszczyk, Richmond (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/839,449

(22) Filed: Aug. 15, 2007

(51) Int. Cl. H01M 8/00

(52) U.S. Cl. 429/13

(57) ABSTRACT

A method of operating a fuel cell system having a fuel cell stack and a humidifier is disclosed. The method includes directing at least a portion of the reactant gas through the reactant chamber of the humidifier, directing at least a portion of the exhaust gas through the exhaust chamber of the humidifier, determining the first pressure drop of the exhaust gas directed through the exhaust chamber, determining the first pressure drop limit of the exhaust gas directed through the exhaust chamber, and bypassing the remainder portion of the exhaust gas from the exhaust gas outlet around the exhaust chamber through the exhaust bypass passageway so that the first pressure drop does not exceed the determined first pressure drop limit.

### BACKGROUND

1. Technical Field

The present invention relates to fuel cell systems and, more specifically, to methods of operating fuel cell systems with a humidification device.

2. Description of the Related Art

Fuel cell systems are currently being developed for use as power supplies in numerous applications, such as automobiles and stationary power plants. Such systems offer promise of delivering power economically and with environmental and other benefits. A current trend in the design of fuel cell systems is to be able to operate fuel cell stacks at lower relative humidities to reduce parasitic power consumption and to reduce the size of the humidification device.

Fuel cells convert reactants, namely, fuel and oxidant, to generate electric power and reaction products. Polymer electrolyte membrane fuel cells employ a membrane electrode assembly (“MEA”) that is interposed between separator or flow field plates for directing the reactants across opposing surfaces of the MEA. The MEA typically includes a solid polymer electrolyte membrane disposed between two electrodes, namely a cathode and an anode.

The water content of the solid polymer electrolyte membrane has a large effect on the performance of the fuel cell. The ion conductivity of the membrane generally increases as the water content or hydration of the membrane increases; therefore, it is desirable to maintain a sufficient level of hydration during fuel cell operation. For this reason, the reactants are typically humidified prior to being supplied to the fuel cell.

One approach to humidify the reactants is described in U.S. Pat. No. 6,106,964. Reactant gas supply streams for solid polymer fuel cells are heated and humidified using heat generated by the fuel cell and water vapor from the fuel cell exhaust. The heat and water vapor in the oxidant exhaust stream are sufficient to heat and humidify a reactant gas supply stream, preferably the oxidant supply stream. The heating and humidifying are accomplished by flowing a reactant gas supply stream and a fuel cell exhaust gas stream on opposite sides of a water permeable membrane in a combined heat and humidity exchange apparatus.

In conventional fuel cell systems, control of the reactant gas humidity level is important for improving fuel cell performance. If the humidity is too low, the resistance of the membrane will increase, leading to higher ohmic resistance. However, if the humidity is too high, water may condense in the fuel cell, leading to increased mass transport losses. One method of controlling the humidity is described in U.S. Pat. No. 6,656,620, which discloses a reaction gas supply passage from the humidifier to the fuel cell; and a reaction gas bypass passage, connected to the reaction gas supply passage, for allowing the reaction gas to bypass the humidifier and for controlling an amount of gas flow. The amount of reaction gas flowing through the reaction gas bypass passage is controlled depending on the amount of humidification required by the fuel cell, and the fuel cell can be used most efficiently.

The selection of suitable membranes for membrane humidifiers is important to prevent intermixing of the reactant and exhaust gases while providing sufficient water transfer from the exhaust gas to the reactant gas. Preferably, the membranes are substantially gas impermeable while permeable to water, for example, Nafion®. However, such membranes are typically expensive and need to be sufficiently thick to tolerate the cross-pressures of the gases to which they may be subjected during fuel cell operation. Furthermore, if the membrane fails, the entire humidifier will need to be replaced because replacement of the membrane is usually difficult.

Accordingly, there remains a need in the art to provide improved methods of humidifying reactant gases using membrane humidifiers while maintaining durability thereof. This invention addresses this problem and provides further related advantages.

### BRIEF SUMMARY

The present method relates to a method of operating a fuel cell system, the fuel cell system comprising: a fuel cell stack comprising an inlet for receiving a reactant gas and an outlet for removing an exhaust gas; a reactant gas supply for supplying the reactant gas to the reactant gas inlet; a humidifier comprising a reactant chamber fluidly connected to and upstream of the fuel cell stack inlet, an exhaust chamber fluidly connected to and downstream of the fuel cell stack outlet, and a water permeable membrane separating the reactant and exhaust chambers; and an exhaust gas bypass passageway fluidly connected across the exhaust chamber.

In one embodiment, the method comprises: directing at least a portion of the reactant gas through the reactant chamber; directing at least a portion of the exhaust gas through the exhaust chamber; determining a first pressure drop of the exhaust gas directed through the exhaust chamber; determining a first pressure drop limit of the exhaust gas directed through the exhaust chamber; and bypassing a remainder portion of the exhaust gas from the exhaust gas outlet around the exhaust chamber through the exhaust bypass passageway so that the first pressure drop does not exceed the determined first pressure drop limit.

In further embodiments, the fuel cell system further comprises a reactant gas bypass passageway fluidly connected across the reactant chamber.

In one embodiment, the method further comprises: determining a second pressure drop of the reactant gas directed through the reactant chamber; determining a second pressure drop limit of the reactant gas directed through the reactant chamber; and bypassing a remainder portion of the reactant gas from the reactant gas supply around the reactant chamber through the reactant bypass passageway so that the second pressure drop does not exceed a second predetermined limit.

In another embodiment, the method further comprises: determining a cross-pressure differential between the reactant gas and the exhaust gas; determining a cross-pressure differential limit between the reactant gas and the exhaust gas; and bypassing a remainder portion of the reactant gas from the reactant gas supply around the reactant chamber through the reactant bypass passageway so that the cross-pressure differential does not exceed the determined cross-pressure differential limit.

In another embodiment, the method comprises: directing at least a portion of the reactant gas through the reactant chamber; directing at least a portion of the exhaust gas through the exhaust chamber; determining a first pressure drop of the reactant gas directed through the reactant chamber; determining a first pressure drop limit of the reactant gas directed through the reactant chamber; and bypassing a remainder portion of the reactant gas from the reactant gas outlet around the reactant chamber through the reactant bypass passageway so that the first pressure drop does not exceed the determined first pressure drop limit.

These and other aspects of the invention will be evident in view of the attached figures and the following detailed description.

### BRIEF DESCRIPTION OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been selected solely for ease of recognition in the figures.

FIG. 1 shows a fuel cell system with a prior art humidification system.

FIG. 2 shows a schematic of a humidification system according to one embodiment of the present invention.

FIG. 3 shows a schematic of a humidification system according to another embodiment of the present invention.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and fuel cell systems have not been shown or described in detail to avoid unnecessarily obscuring descriptions of the embodiments of the invention.

Unless the context requires otherwise, throughout the specification and claims which follow, the word “comprise” and variations thereof, such as “comprises” and “comprising”, are to be construed in an open, inclusive sense, that is, as “including but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the present context, “relative humidity” means the ratio of the partial pressure of water vapor in the fuel or air stream, compared to the partial pressure of water that the fuel or air stream can hold if it was fully saturated.

As used herein, “load” means current (expressed in amperes) or current density (expressed in amperes/unit surface area of a fuel cell).

In the present context, “pressure drop” means the pressure difference between an inlet of a particular chamber and an outlet of the same chamber, and “cross-pressure differential” means the pressure difference at any point between the reactant chamber and the exhaust chamber.

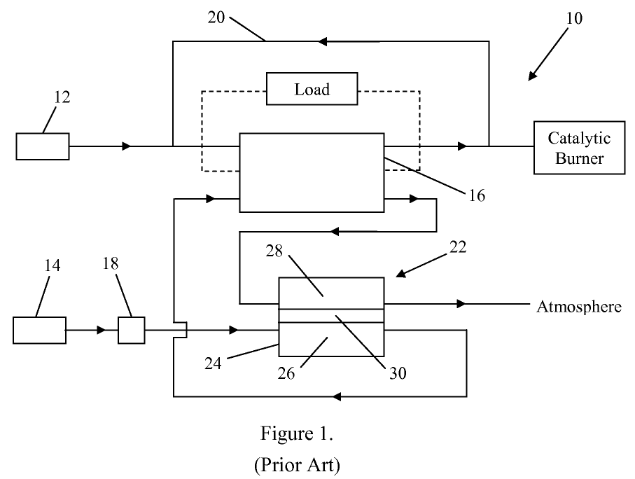

FIG. 1 illustrates a fuel cell system with a prior art humidification system. Fuel cell system 10 includes a fuel supply 12 for providing an anode reactant gas, and an oxidant supply 14 for providing a cathode reactant gas, to fuel cell stack 16. Typically, a compressor 18 is used to pressurize the cathode reactant gas to a desirable operating pressure, particularly if the cathode reactant gas is ambient air. Anode exhaust gas is discharged from fuel cell stack 16 and a portion is recirculated through recirculation loop 20, while a remainder portion is vented to a catalytic burner or the atmosphere (not shown). Cathode exhaust gas is discharged from fuel cell stack 16 and directed to a humidification system 22. Humidification system 22 contains a humidifier 24 having a reactant chamber 26 and an exhaust chamber 28, which are separated by a water permeable membrane 30.

During fuel cell operation, cathode reactant gas is provided to compressor 18 and reactant chamber 26 of humidifier 24 prior to fuel cell stack 16. The cathode reactant gas electrochemically reacts with protons in the cathodes of fuel cell stack 16, thereby producing heat and water. Thus, the cathode exhaust gas that leaves fuel cell stack 16 will be warmer and will have a higher partial pressure of water than the cathode reactant gas. As the cathode exhaust gas from fuel cell stack 16 is directed back to exhaust chamber 28 of humidifier 24, water vapor is transferred from the cathode exhaust gas through membrane 30 to the cathode reactant gas in reactant chamber 26. After transferring heat and water vapor, the cathode exhaust gas leaves exhaust chamber 28 and is vented to the atmosphere. Optionally, a portion of the cathode exhaust gas may be recirculated back to the fuel cell stack (not shown).

One purpose of compressor 18 is to pressurize the cathode reactant gas from oxidant supply 14 so that the cathode reactant gas is supplied to fuel cell stack 16 at a desired pressure. Thus, compressor 18 must sufficiently pressurize the cathode reactant gas so that it overcomes the pressure drop of fuel cell stack 16. However, as discussed in the foregoing, the cathode reactant gas is humidified by passing the cathode reactant gas through reactant chamber 26 simultaneously with the cathode exhaust gas through exhaust chamber 28. Thus, compressor 18 must supply the cathode reactant gas so that it sufficiently overcomes the pressure drop of reactant and exhaust chambers 26, 28, in addition to fuel cell stack 16. However, one skilled in the art will appreciate that the load drawn by compressor 18 increases with increasing pressure to which it pressurizes the cathode reactant gas, which also increases with increasing pressure drop of fuel cell stack 16 and reactant and exhaust chambers 26, 28.

Accordingly, the present invention is related to a fuel cell system with an improved humidification system and methods of operating the fuel cell system, wherein the amount of gas directed through the reactant chamber and/or exhaust chamber is varied to obtain a desired pressure drop of the gases flowing through the humidifier. For example, the amount of gas directed through the reactant chamber and/or exhaust chamber may be reduced to reduce the pressure drop of the gases, thereby reducing the load drawn by the compressor. Typical prior art methods of operating fuel cell systems control the amount of reactant and exhaust gas flowing through the humidifier to achieve the desired relative humidity level of the reactant gas entering the stack. However, as the design of membrane electrode assemblies and fuel cell stacks advances, fuel cell stacks can more readily operate within a range of relative humidity levels for a given power level. Thus, strict control of the relative humidity levels is not necessary.

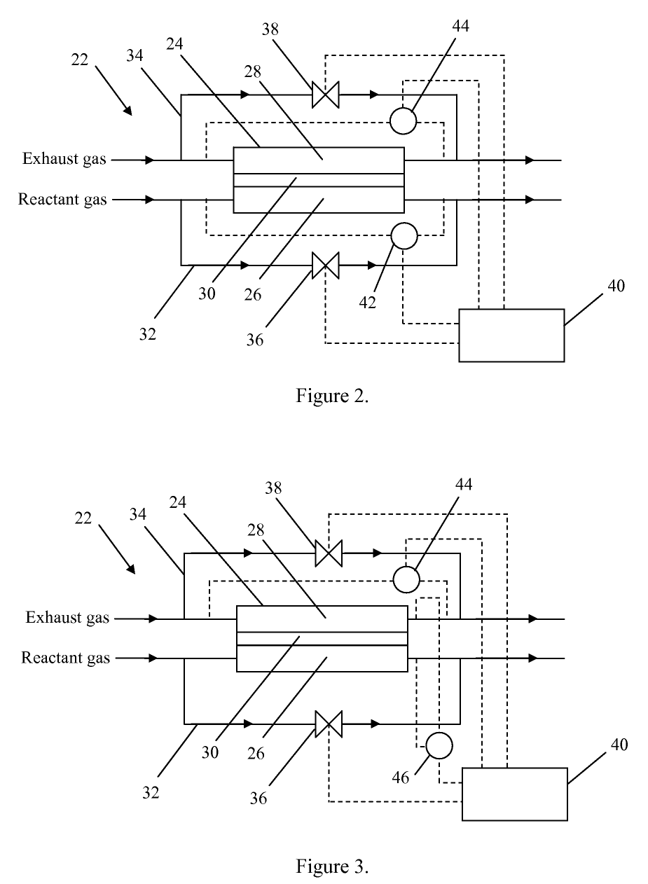

In an exemplary humidification system of the present invention, as shown in FIG. 2, humidification system 22 employs bypass passageways 32, 34 to divert a portion of the cathode reactant and exhaust gases, respectively, around humidifier 24. Valves 36, 38 in bypass passageways 32, 34 may be controlled by a controller 40 to vary the quantity of the cathode reactant and exhaust gases, respectively, directed through humidifier 24 relative to the quantity of the cathode reactant and exhaust gases directed through bypass passageways 32, 34, respectively. Representative examples of valves include, but are not limited to, solenoid valves and butterfly motorized valves. Differential pressure sensor 42 detects the pressure drop of the reactant gas flowing through reactant chamber 26, while differential pressure sensor 44 detects the pressure drop of the exhaust gas flowing through exhaust chamber 28.

During operation, an electrical load (see FIG. 1) is drawn from the fuel cell stack and a pressure drop limit of the cathode exhaust gas through exhaust chamber 28 is determined by controller 40 based on the electrical load drawn (or any other fuel cell operating parameter indicative of the electrical load, such as, but not limited to, the reactant stoichiometry, reactant pressures, stack temperature, and voltage). The amount of cathode exhaust gas bypassing exhaust chamber 28 is then controlled by adjusting valve 38 so that the pressure drop of the cathode exhaust gas flowing through exhaust chamber 28 is equal to or less than the pressure drop limit.

Similarly, a pressure drop limit of the cathode reactant gas through reactant chamber 26 is determined by controller 40 based on the load drawn. The amount of cathode reactant gas bypassing humidifier 24 is then controlled by adjusting valve 36 so that the pressure drop of the cathode reactant gas flowing through reactant chamber 26 is equal to or less than the pressure drop limit. Thus, the pressure drop of the gases flowing through reactant chamber 26 and exhaust chamber 28 can be reduced so that parasitic power consumed by compressor 18 is also reduced.

The pressure drop limit of the cathode exhaust gas through exhaust chamber 28 and/or the cathode reactant gas through reactant chamber 26 may readily determined by one skilled in this field for any given fuel cell system, depending on the design of the humidifier, and will typically be in the range of about 0 to 25 kPa, usually about 1 to 10 kPa, and typically about 1 to 5 kPa.

In another embodiment, as shown in FIG. 3, differential pressure sensor 46 determines the cross-pressure differential (i.e., pressure difference between the reactant gas in reactant chamber 26 and the exhaust gas in exhaust chamber 28). Control of the cross-pressure differential is desirable to reduce the stress on membrane 28 and to improve durability. In this embodiment, during operation, a cross-pressure differential limit is determined by controller 40 based on the load, and the amount of cathode reactant gas bypassing exhaust chamber 28 is controlled by adjusting valve 36 so that the cross-pressure differential is equal to or less than the cross-pressure differential limit. In some embodiments, the cross-pressure differential may be determined by measuring the reactant inlet pressure and exhaust inlet pressure, the reactant inlet pressure and the exhaust outlet pressure, and/or the reactant outlet pressure and the exhaust outlet pressure (as shown in FIG. 3). As with the pressure drop limit, the cross-pressure differential limit may readily be determined by one skilled in the field for any given fuel cell system, depending on the operating parameters of the fuel cell stack, and will typically be in the range of about 0 to 25 kPa, usually about 1 to 10 kPa, and typically about 1 and 5 kPa.

Alternatively, a pressure drop limit of the cathode reactant gas through reactant chamber 26 and a cross-pressure differential limit may be determined by controller 40 based on the load drawn. The amount of cathode reactant gas bypassing reactant chamber 26 is then controlled so that the pressure drop is equal to or less than the pressure drop limit, while the amount of cathode exhaust gas bypassing exhaust chamber 28 is controlled so that the cross-pressure differential is equal to or less than the cross-pressure differential limit (not shown).

In the embodiments described above, the cathode reactant gas is directed through reactant chamber 26 so that the cathode reactant gas is humidified. Alternatively, the anode reactant gas may be directed through reactant chamber 26 so that the anode reactant gas is humidified. In addition, the gases flowing through fuel cell stack 16 and humidifier 24 are shown to be in a co-flow configuration (i.e., flowing in the same direction). However, the gases flowing through fuel cell stack 16 and/or humidifier 24 may be in a counter-flow configuration (i.e., flowing in opposite directions), although this configuration may result in a higher cross-pressure differential in fuel cell stack 16 and/or humidifier 24.

In addition, in any of the embodiments described above, individual pressure sensors may replace any of the differential pressure sensors, though this will increase the number of sensors in the fuel cell system.

The present invention may be implemented by controller 40, which is communicatively coupled to receive signals from various sensors (e.g., temperatures, pressures, stoichiometries), and/or to control the states of the reactants as well as other fuel cell system components, such as pumps, compressors, and the like. In one embodiment, controller 40 may receive signals indicative of the pressure drops of the reactant and exhaust gases in the reactant and exhaust chambers, respectively. The controller then looks up pressure drop limits of the reactant gas and the exhaust gas in the humidifier based on the load, and controls the quantity of reactant gas and exhaust gas bypassing the humidifier to achieve the predetermined pressure drops. In another embodiment, the controller may receive signals indicative of the pressure drop of the exhaust gas and the cross-pressure differential of the reactant and exhaust gases flowing through the humidifier. The controller then looks up the exhaust pressure drop limit of the exhaust gas and the cross-pressure differential limit based on the load, and controls the quantity of reactant gas and exhaust gas bypassing the humidifier to so that the exhaust pressure drop and cross-pressure differential do not exceed these limits.

The controller may take a variety of forms such as microprocessors, microcontrollers, application-specific integrated circuits (ASIC), and/or digital signal processors (DSP), with or without associated memory structures such as read only memory (ROM) and/or random access memory (RAM). In some embodiments, the controller may be configured to store a plurality of predetermined reactant and exhaust pressure drops, and/or cross-pressure differential, based on the load in the form of a look-up table, for example. Alternatively, the controller may be configured to store a mathematical equation or function to calculate predetermined reactant and exhaust pressure drops, and/or cross-pressure differential, based on the load.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

1. A method of operating a fuel cell system, the fuel cell system comprising a fuel cell stack comprising an inlet for receiving a reactant gas and an outlet for removing an exhaust gas; a reactant gas supply for supplying the reactant gas to the reactant gas inlet; a humidifier comprising a reactant chamber fluidly connected to and upstream of the fuel cell stack inlet, an exhaust chamber fluidly connected to and downstream of the fuel cell stack outlet, and a water permeable membrane separating the reactant and exhaust chambers; and an exhaust gas bypass passageway fluidly connected across the exhaust chamber; the method comprising:
directing at least a portion of the reactant gas through the reactant chamber;
directing at least a portion of the exhaust gas through the exhaust chamber;
determining a first pressure drop of the exhaust gas directed through the exhaust chamber;
determining a first pressure drop limit of the exhaust gas directed through the exhaust chamber; and
bypassing a remainder portion of the exhaust gas from the exhaust gas outlet around the exhaust chamber through the exhaust bypass passageway so that the first pressure drop does not exceed the determined first pressure drop limit.

2. The method of claim 1, wherein the fuel cell system further comprises at least one pressure sensor for determining the first pressure drop.

3. The method of claim 1, wherein determining the first pressure drop limit comprises:
determining an electrical load drawn from the fuel cell stack; and
determining the first pressure drop limit based on the electrical load.

4. The method of claim 1, wherein the fuel cell system further comprises a reactant gas bypass passageway fluidly connected across the reactant chamber, the method further comprising:
determining a second pressure drop of the reactant gas directed through the reactant chamber;
determining a second pressure drop limit of the reactant gas directed through the reactant chamber; and
bypassing a remainder portion of the reactant gas from the reactant gas supply around the reactant chamber through the reactant bypass passageway so that the second pressure drop does not exceed a second predetermined limit.

5. The method of claim 1, wherein the fuel cell system further comprises a reactant gas bypass passageway fluidly connected across the reactant chamber, further comprising:
determining a cross-pressure differential between the reactant gas and the exhaust gas;
determining a cross-pressure differential limit between the reactant gas and the exhaust gas; and
bypassing a remainder portion of the reactant gas from the reactant gas supply around the reactant chamber through the reactant bypass passageway so that the cross-pressure differential does not exceed the determined cross-pressure differential limit.

6. The method of claim 5, wherein the fuel cell system further comprises at least one pressure sensor for determining the cross-pressure differential.

7. The method of claim 5, wherein determining the cross-pressure differential limit comprises:
determining an electrical load drawn from the fuel cell stack; and
determining the cross-pressure differential limit based on the electrical load.

8. The method of claim 1, wherein the reactant gas is an oxidant reactant gas and the exhaust gas is an oxidant exhaust gas.

9. The method of claim 1, wherein the reactant gas is a fuel reactant gas and the exhaust gas is an oxidant exhaust gas.

10. A method of operating a fuel cell system, the fuel cell system comprising a fuel cell stack comprising an inlet for receiving a reactant gas and an outlet for removing an exhaust gas; a reactant gas supply for supplying the reactant gas to the reactant gas inlet; a humidifier comprising a reactant chamber fluidly connected to and upstream of the fuel cell stack inlet, an exhaust chamber fluidly connected to and downstream of the fuel cell stack outlet, and a water permeable membrane separating the reactant and exhaust chambers; and an exhaust gas bypass passageway fluidly connected across the exhaust chamber; the method comprising:
directing at least a portion of the reactant gas through the reactant chamber;
directing at least a portion of the exhaust gas through the exhaust chamber;
determining a first pressure drop of the reactant gas directed through the reactant chamber;
determining a first pressure drop limit of the reactant gas directed through the reactant chamber; and
bypassing a remainder portion of the reactant gas from the reactant gas outlet around the reactant chamber through the reactant bypass passageway so that the first pressure drop does not exceed the determined first pressure drop limit.

11. The method of claim 10, wherein the fuel cell system further comprises at least one pressure sensor for determining the first pressure drop.

12. The method of claim 10, wherein determining the first pressure drop limit comprises:
determining an electrical load drawn from the fuel cell stack; and
determining the first pressure drop limit based on the electrical load.

13. The method of claim 10, wherein the fuel cell system further comprises an exhaust gas bypass passageway fluidly connected across the exhaust chamber, further comprising:
determining a cross-pressure differential between the reactant gas and the exhaust gas;
determining a cross-pressure differential limit between the reactant gas and the exhaust gas; and
bypassing a remainder portion of the exhaust gas from the exhaust gas supply around the exhaust chamber through the exhaust bypass passageway so that the cross-pressure differential does not exceed the determined cross-pressure differential limit.

14. The method of claim 13, wherein the fuel cell system further comprises at least one pressure sensor for determining the cross-pressure differential.

15. The method of claim 13, wherein determining the cross-pressure differential limit comprises:
determining an electrical load drawn from the fuel cell stack; and
determining the cross-pressure differential limit based on the electrical load.

16. The method of claim 10, wherein the reactant gas is an oxidant reactant gas and the exhaust gas is an oxidant exhaust gas.

17. The method of claim 10, wherein the reactant gas is a fuel reactant gas and the exhaust gas is an oxidant exhaust gas.
